(19) United States
(12) Patent Application Publication
(10) Pub. No.: US 2026/0349485 A1
(43) Pub. Date: Nov. 5, 2026

(54) Proactive Thermal Throttling Based on Forecasted Temperature Data

(71) Applicant: Google LLC, Mountain View, CA (US)

(72) Inventors: Sayanna Chandula, San Jose, CA (US); Jikai Ma, Coquitlam (CA); TeYuan Wang, Mountain View, CA (US); Jagdish Singh Babra, Morgan Hill, CA (US)

(73) Assignee: Google LLC, Mountain View, CA (US)

(21) Appl. No.: 19/711,488

(22) Filed: Jun. 17, 2026

(51) Int. Cl. G06F 1/20; G01W 1/10

(52) U.S. Cl. CPC G06F 1/206; G01W 1/10

(57) ABSTRACT

Techniques and apparatuses are described for performing proactive thermal throttling based on forecasted temperature data. In example aspects, a thermal control system controls an internal temperature of a computing device to protect the computing device from being damaged due to overheating, to maintain reliability of the computing device, and to avoid creating a potentially unsafe situation for the user to operate the computing device. The thermal control system performs temperature forecasting to generate forecasted temperature data based at least on measured temperature data. The thermal control system performs proactive thermal throttling by comparing the forecasted temperature data to a target temperature. If the forecasted temperature data meets or exceeds the target temperature, the thermal control system activates one or more cooling techniques to maintain the temperature of the computing device below a temperature limit, such as at the target temperature.

### SUMMARY

Techniques and apparatuses are described for performing proactive thermal throttling based on forecasted temperature data. In example aspects, a thermal control system controls an internal temperature of a computing device to protect the computing device from being damaged due to overheating, to maintain reliability of the computing device, and to avoid creating a potentially unsafe situation for the user to operate the computing device. The thermal control system performs temperature forecasting to generate forecasted temperature data based at least on measured temperature data. In some implementations, the thermal control system also evaluates other types of data to generate the forecasted temperature data, including measured secondary data and/or status data. The thermal control system performs proactive thermal throttling by comparing the forecasted temperature data to a target temperature. If the forecasted temperature data meets or exceeds the target temperature, the thermal control system activates one or more cooling techniques to maintain the temperature of the computing device below a temperature limit, such as at the target temperature.

### BRIEF DESCRIPTION OF DRAWINGS

Apparatuses and techniques for implementing proactive thermal throttling based on forecasted temperature data are described with reference to the following drawings. The same numbers are used throughout the drawings to reference like features and components:

FIG. 1 illustrates an example environment in which proactive thermal throttling based on forecasted temperature data can be implemented;

FIG. 2 illustrates an example computing device that can perform proactive thermal throttling based on forecasted temperature data;

FIG. 3 illustrates example timing diagrams associated with performing proactive thermal throttling based on forecasted temperature data;

FIG. 4 illustrates a first example implementation of a forecaster that can perform temperature forecasting to support proactive thermal throttling based on forecasted temperature data;

FIG. 5 illustrates a second example implementation of a forecaster that can perform temperature forecasting to support proactive thermal throttling based on forecasted temperature data; and

FIG. 6 illustrates an example method for performing proactive thermal throttling based on forecasted temperature data.

### DETAILED DESCRIPTION

### Overview

As an electronic device provides features for a user, its operation can generate heat. Left unchecked, the accumulation of heat within the electronic device can result in a high temperature that can damage internal components of the electronic device and/or can reduce the reliability of the electronic device. In some cases, the electronic device can become unsafe for the user to operate.

To reduce the temperature, electronic devices can utilize active or passive cooling techniques. An example active cooling technique employs one or more fans to push hot air out of the electronic device and/or to bring cool air into the electronic device. An example passive cooling technique adjusts an operational point of one or more components within the electronic device to decrease power consumption, such as through dynamic voltage and/or frequency scaling or by powering off components. These cooling techniques can have a downside, however. The fan, for instance, consumes power, which can drain the electronic device's battery. The passive cooling techniques decrease performance of the electronic device, which can degrade the user experience. It is therefore desirable to employ these cooling techniques only when necessary.

Generally speaking, an electronic device has a temperature limit. If temperatures meet or exceed the temperature limit, one or more components of the electronic device can become damaged and/or the reliability of the electronic device can be degraded. These higher temperatures can also degrade the user experience. Even though surface temperatures may technically be safe, holding a hot device can be uncomfortable for a user. It is therefore desirable to keep the temperature of the electronic device below the temperature limit. One strategy in thermal management involves allowing the electronic device to increase in temperature until a target temperature is reached. The target temperature represents a setpoint that is below the temperature limit of the electronic device. Some electronic devices activate one or more cooling techniques once a measured temperature of the electronic device is greater than or equal to the target temperature. While this activation technique avoids unnecessary performance throttling, it is susceptible to overshoot, which means that the measured temperature may reach or exceed the temperature limit before the activated cooling techniques can cause the measured temperature to settle at the target temperature.

To address the overshoot, other activation techniques engage the cooling techniques earlier based on an offset temperature that is less than the target temperature. Once the measured temperature meets or exceeds this offset temperature, the cooling techniques are activated. By activating the cooling techniques before the measured temperature reaches the target temperature, any overshoot can be kept below the temperature limit. This activation technique, however, can waste power and/or throttle performance in situations that the measured temperature would have settled at a level that was between the offset temperature and the target temperature without the utilization of any cooling techniques.

To address these problems, techniques are described for performing proactive thermal throttling based on forecasted temperature data. In example aspects, a thermal control system controls an internal temperature of a computing device to protect the computing device from being damaged due to overheating, to maintain reliability of the computing device, and to avoid creating a potentially unsafe situation for the user to operate the computing device. The thermal control system performs temperature forecasting to generate forecasted temperature data based at least on measured temperature data. In some implementations, the thermal control system also evaluates other types of data in addition to the measured temperature data to generate the forecasted temperature data, including measured secondary data and/or status data. The thermal control system performs proactive thermal throttling by comparing the forecasted temperature data to a target temperature. If the forecasted temperature data meets or exceeds the target temperature, the thermal control system activates one or more cooling techniques to maintain the temperature of the computing device below a temperature limit, such as at the target temperature.

By relying on forecasted temperature data instead of measured temperature data to perform proactive thermal throttling, the thermal control system can avoid the overshoot problem associated with other thermal management techniques. The thermal control system can also avoid prematurely or unnecessarily activating cooling techniques, thereby improving overall performance of the computing device and improving the user experience. In this way, thermal throttling is engaged if the forecasted temperature data indicates that the temperature is estimated to reach the target temperature. With proactive thermal throttling based on forecasted temperature data, the target temperature can be set closer to the temperature limit of the computing device (e.g., within 1% or less). Proactive thermal throttling also enables the enclosure temperature of the computing device to be directly managed, thereby improving the overall tactile thermal experience of the user.

### Operating Environment

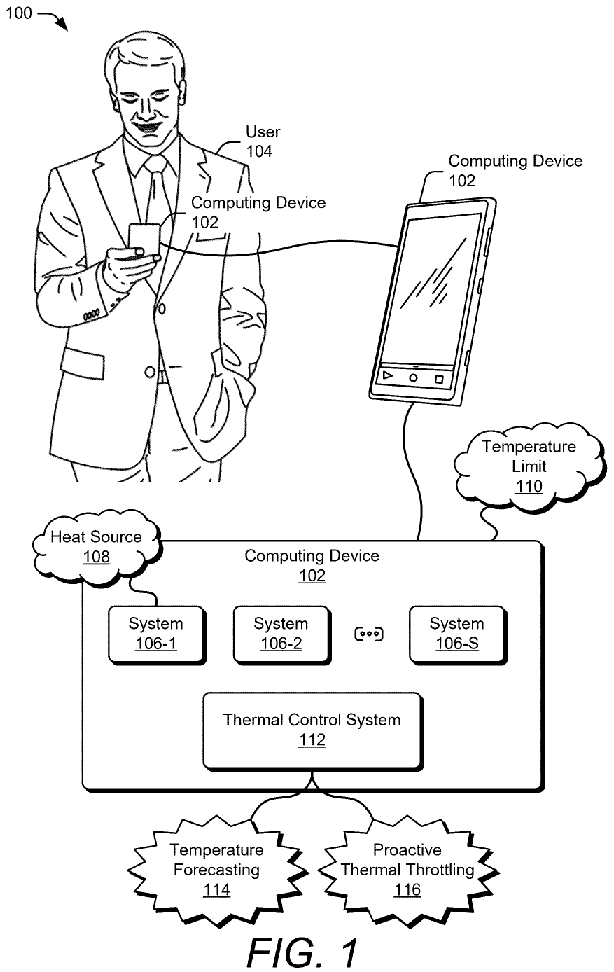

FIG. 1 is an illustration of an example environment 100 in which proactive thermal throttling based on forecasted temperature data can be implemented. In the example environment 100, a computing device 102 provides features and/or services for a user 104. Although depicted as a smartphone, the computing device 102 can include other types of devices, including a desktop computer, a tablet, a laptop, a television, a computing watch, computing glasses, a gaming system, a microwave, or a vehicle. Other devices may also be used, such as a home service device, a smart speaker, a smart thermostat, a baby monitor, a Wi-Fi® router, a drone, a trackpad, a drawing pad, a netbook, an e-reader, a home automation and control system, a wall display, and another home appliance. Note that the computing device 102 can be wearable, non-wearable but mobile, or relatively immobile (e.g., desktops and appliances).

The computing device 102 includes at least one system 106, such as systems 106-1, 106-2 . . . 106-S, where S represents a positive integer. Each system 106 can represent a component or a collection of components, and can also be referred to as agents, modules, intellectual-property blocks (IP blocks), or intellectual-property cores. Example systems 106 include a central processing unit (CPU), a graphics processing unit (GPU), an image processing unit (IPU), a modem, a wireless communication module, a digital signal processor (DSP), a tensor processing unit (TPU), a neural processing unit (NPU), a power processing unit (PPU), a system-on-chip (SoC), a microchip, an application-specific integrated circuit (ASIC), an application-specific standard product (ASSP), a programmable system-on-chip (PSoC), a system-in-package (SiP), a controller, a display, a speaker, a processor, a memory, a sensor (e.g., a camera, an ambient light sensor, a temperature sensor, a radar sensor), an analog circuit, a digital circuit, components that handle application-specific processing functions, and so forth.

One or more of the systems 106 represent a heat source 108. While operating, these systems 106 generate heat, which can contribute to increasing an internal temperature of the computing device 102. Left unchecked, the accumulation of heat within the computing device 102 can result in a temperature that meets or exceeds a temperature limit 110 of the computing device 102. In this situation, the high temperature can damage the system 106, can damage other components of the computing device 102, and/or can reduce a reliability of the computing device 102. In some cases, the high temperature can cause the computing device 102 to become unsafe for the user 104 to operate.

To avoid these situations, the computing device 102 includes at least one thermal control system 112. The thermal control system 112 manages or controls the temperature of the computing device 102 to protect the computing device 102 from being damaged due to overheating, to maintain reliability, and to avoid creating a potentially unsafe situation for the user 104 to operate the computing device 102. To do this, the thermal control system 112 performs temperature forecasting 114 to generate forecasted temperature data based at least on measured temperature data. The thermal control system 112 also performs proactive thermal throttling 116 based on the forecasted temperature data. With proactive thermal throttling 116, the thermal control system 112 can activate one or more active or passive cooling techniques to cause the temperature of the computing device 102 to remain below the temperature limit 110.

In various implementations, the thermal control system 112 can be implemented using software, firmware, fixed logic circuitry, and so forth. In a first example implementation, the thermal control system 112 represents one of the systems 106. In a second example implementation, the thermal control system 112 is integrated within or considered part of one of the systems 106. For example, the thermal control system 112 can be implemented using the CPU, GPU, or TPU.

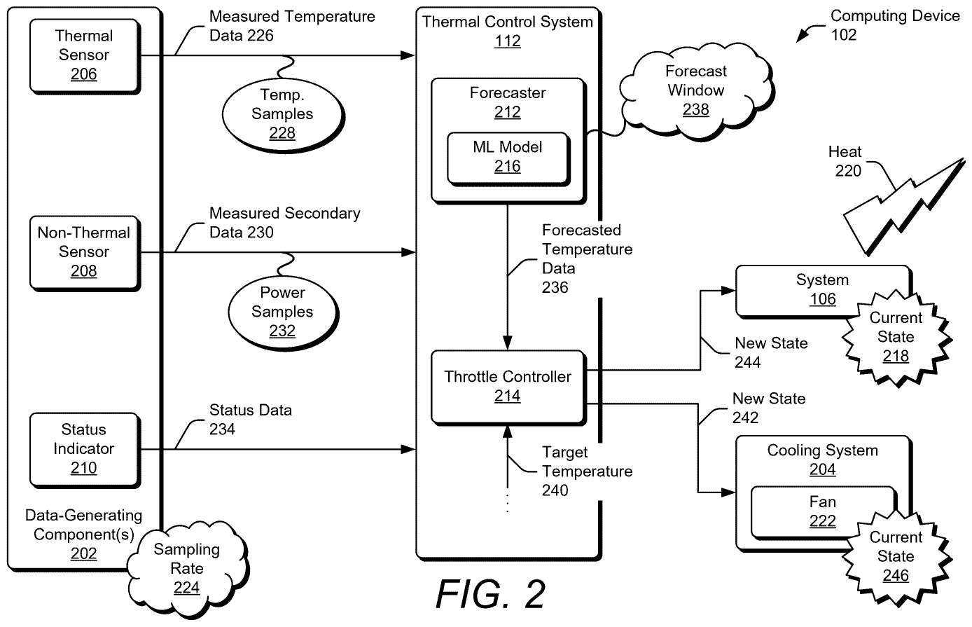

By performing proactive thermal throttling 116 based on forecasted temperature data, the thermal control system 112 can avoid activating cooling techniques in scenarios where the forecasted temperature data is projected to remain below a target temperature. Additionally, the thermal control system 112 can apply more aggressive throttling measures for situations in which the forecasted temperature data is projected to reach or exceed the target temperature threshold. With temperature forecasting 114, the thermal control system 112 can also appropriately time activation of passive cooling techniques for systems 106 that have an inherent time delay in responding to throttling requests. In this way, these systems 106 can reach a desired power state at the moment the target temperature is reached. The thermal control system 112 is further described with respect to FIG. 2.

### Proactive Thermal Throttling Based on Forecasted Temperature Data

FIG. 2 illustrates an example computing device 102 that can implement proactive thermal throttling 116 based on forecasted temperature data. In the depicted configuration, the computing device 102 includes the system 106, the thermal control system 112, one or more data-generating components 202, and optionally at least one cooling system 204. The thermal control system 112 is communicatively coupled to the data-generating components 202, the system 106, and the cooling system 204. Although a single system 106 is depicted in FIG. 2, it is to be understood that the thermal control system 112 can be coupled to more than one system 106.

The data-generating component 202 provides input data to the thermal control system 112 for performing temperature forecasting 114. The data-generating component 202 includes at least one thermal sensor 206, which measures an internal temperature of the computing device 102. In some implementations, the thermal sensor 206 can be implemented as part of the system 106 or the cooling system 204. The computing device 102 can include multiple thermal sensors 206 that are located at different positions within the computing device 102. In this case, each thermal sensor 206 can measure a temperature associated with a particular region of the computing device 102.

The data-generating component 202 can optionally include at least one non-thermal sensor 208, which measures a non-temperature parameter that can contribute to the internal temperature of the computing device 102 or can provide context for the internal temperature of the computing device 102. In various examples, the non-temperature parameter can represent an internal or external condition that can be measured and sampled by the computing device 102. In a first example, the non-thermal sensor 208 is a power-monitoring sensor that can measure an amount of power that is being consumed by the system 106 and/or by the computing device 102. In general, there is a direct relationship between temperature and power. Absent any active cooling techniques, the temperature of the computing device 102 is likely to increase as power consumption increases. Likewise, the temperature of the computing device 102 is likely to decrease as power consumption decreases. In a second example, the non-thermal sensor 208 is a proximity sensor that can measure a proximity of the user 104 to the computing device 102. The proximity of the user 104 can indicate how likely the user 104 is to interact with the computing device 102 in the future. If the user 104 is approaching the computing device 102, usage is likely to increase and cause a corresponding increase in temperature. If the user 104 is moving away from the computing device 102, usage is likely to decrease and cause a corresponding decrease in temperature. In a third example, the non-thermal sensor 208 is a hinge sensor that can measure an angle of the hinge to determine a degree at which the computing device 102 is open or closed. This angle can indicate whether the user 104 is likely interacting with the computing device 102 or can indicate different configurations of the computing device 102 that can dissipate different amounts of heat. Other types of non-thermal sensors 208 are also possible, including an ambient light sensor, a hand-grip or pressure sensor, a position or inertial sensor, an image sensor, and so forth. These non-thermal measurements can provide additional context for performing temperature forecasting 114.

Additionally or alternatively, the data-generating component 202 can optionally include at least one status indicator 210. The status indicator 210 can collect data associated with a particular state or configuration of the computing device 102. Example data can include a brightness of a display of the computing device 102, a charging status indicator, an indicator of whether a flashlight of the computing device 102 is on or off, an indicator of whether the display is on or off, an indicator of whether the cooling system 204 is on or off, and so forth. The data generated or collected by the one or more data-generating components 202 is passed to the thermal control system 112.

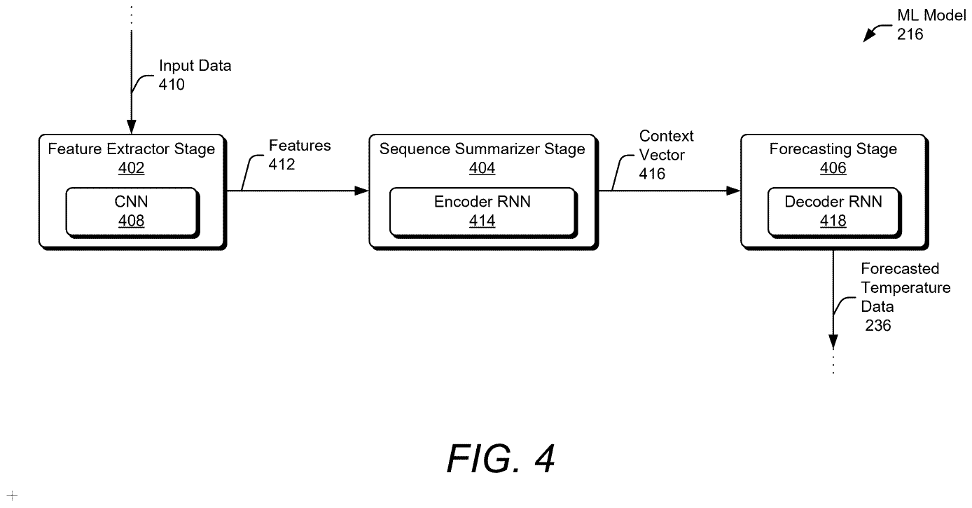

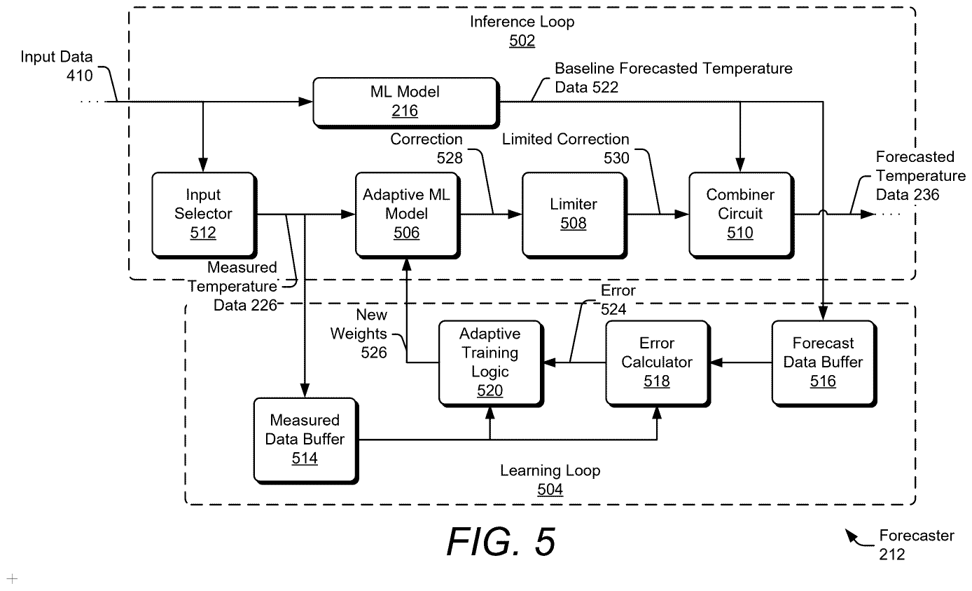

The thermal control system 112 can be implemented using at least one forecaster 212 and at least one throttle controller 214. The forecaster 212 performs temperature forecasting 114 based on the data provided by the data-generating components 202. In an example implementation, the forecaster 212 is implemented using a machine-learned model 216. The machine-learned model 216 can be trained using supervised learning and/or reinforcement learning. The machine-learned model 216 can be implemented using one or more neural networks. A neural network includes a group of connected nodes (e.g., neurons or perceptrons), which are organized into one or more layers. As an example, the machine-learned model 216 includes a deep neural network with an input layer, an output layer, and one or more hidden layers positioned between the input layer and the output layer. The nodes of the deep neural network can be partially-connected or fully-connected between the layers. Example implementations of the machine-learned model 216 are further described with respect to FIGS. 4 and 5.

The throttle controller 214 performs proactive thermal throttling 116, which includes activating one or more cooling techniques. In more detail, the throttle controller 214 can control an operation of the cooling system 204 to employ active cooling techniques and/or can control an operation of the system 106 to employ passive cooling techniques. The throttle controller 214 can be implemented using software, hardware, fixed logic circuitry, firmware, and so forth. In an example implementation, the throttle controller 214 includes at least one comparator.

Consider a situation in which the computing device 102 is turned on and the temperature of the computing device 102 is less than the temperature limit 110. During operations, the system 106 operates in a current state 218 and generates heat 220. Depending on the type of system 106, the current state 218 can represent a first clock frequency, a first supply voltage, a first level of brightness, a first volume level, a first type of radio access technology (e.g., a Fifth-Generation (5G) radio access technology), and/or a first state (e.g., an on state). At this time, the cooling system 204 is also in a current state 246. Consider an example in which the cooling system 204 includes at least one fan 222. In this situation, the current state 246 of the fan 222 can indicate that the fan 222 is off or is operating at a low speed.

The one or more data-generating components 202 generate data at a particular sampling rate 224. Example sampling rates 224 can vary depending on the target thermal management performance and available power resources. In general, the sampling rates 224 can involve generating data at time intervals of a few milliseconds to generating data at time intervals of several seconds (e.g., every one, two, five, ten seconds and so forth). For example, the thermal sensor 206 generates measured temperature data, which includes multiple measurements of the internal temperature of the computing device 102, which is represented by temperature samples 228. The non-thermal sensor 208 generates measured secondary data 230. If the non-thermal sensor 208 is a power measurement sensor, the measured secondary data 230 can include power samples 232. Other types of measured secondary data 230 are also possible (e.g., proximity data, hinge angle data, or ambient light data). In general, the measured secondary data 230 includes measurements that are different than the measured temperature data 226 but can provide additional context that can improve the temperature forecasting 114. The status indicator 210 generates status data 234, which can represent an operational configuration associated with the computing device 102. In some cases, the status data 234 can represent an operational configuration of one or more of the systems 106. The data-generating components 202 pass the generated data to the thermal control system 112.

The forecaster 212 generates forecasted temperature data 236 based at least on the measured temperature data 226. If additional data is provided (e.g., the measured secondary data 230 and/or the status data 234), the forecaster 212 can further generate the forecasted temperature data 236 based on the measured temperature data 226 and the additional data that is provided by the data-generating components 202. The forecasted temperature data 236 is shifted forward in time relative to a time period associated with the measured temperature data 226. This amount of time shift is represented by the forecast window 238. In an example implementation, the forecast window 238 can be one or two minutes ahead of a time at which the most recent temperature sample 228 was measured. In general, the sampling rate 224 and the forecast window 238 can be chosen based on a desired level of responsiveness for proactive thermal throttling 116, based on the computing device's 102 ability to control its temperature, based on the severity associated with exceeding the temperature limit 110, based on the amount of available power, and/or based on the amount of available computing power. In some implementations, the sampling rate 224 and/or the forecast window 238 can be dynamically adjusted based on the current operating conditions (e.g., based on the measured temperature data 226 and/or based on the computing device 102 being in a low-power state).

The throttle controller 214 compares the forecasted temperature data 236 to a target temperature 240. The target temperature 240 represents a temperature that is below but close to the temperature limit 110. In example implementations, the target temperature 240 is within approximately 1% of the temperature limit 110. The throttle controller 214 can activate one or more cooling techniques to maintain the temperature of the computing device 102 at the target temperature 240 and to prevent the temperature from reaching the temperature limit 110. With proactive thermal throttling 116 based on the forecasted temperature data 236, the one or more cooling techniques can be activated in response to the forecasted temperature data 236 being greater than or equal to the target temperature 240.

To activate an active cooling technique, the throttle controller 214 can determine a new state 242 of the cooling system 204 and cause the cooling system 204 to transition from the current state 246 to the new state 242. In this example, the new state 242 can cause the fan 222 to turn on or to operate at a higher speed. To activate a passive cooling technique, the throttle controller 214 can determine a new state 244 of the system 106 and cause the system 106 to transition from the current state 218 to the new state 244. The new state 244, for instance, can indicate a second clock frequency that is slower than the first clock frequency, a second supply voltage that is lower than the first supply voltage, a second level of brightness that is lower than the first level of brightness, a second volume level that is lower than the first volume level, a second type of radio access technology that consumes less power than the first type of radio access technology (e.g., a Fourth-Generation (4G) radio access technology), and/or a second state (e.g., an off state). Other example passive cooling techniques can include reducing power consumption by scaling back device features, such as reducing a frame rate for camera recording, dynamically throttling gaming graphics to a lower quality, or reducing a resolution of a video call.

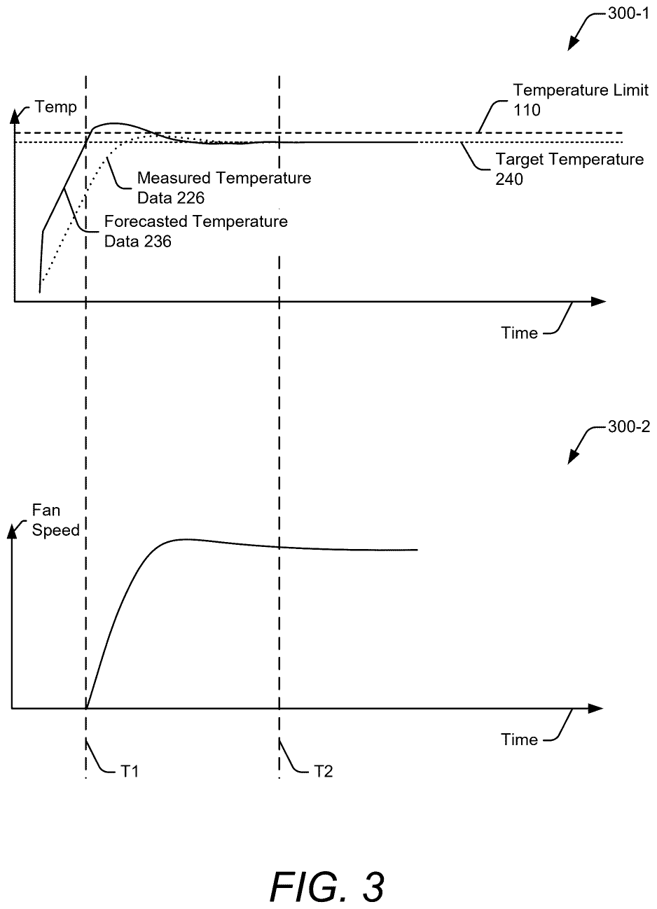

After the forecasted temperature data 236 meets or exceeds the target temperature 240, the throttle controller 214 can evaluate the forecasted temperature data 236 to determine if the one or more cooling techniques can be deactivated or throttled. For example, if the forecasted temperature data 236 is shown to decrease below the target temperature 240, the throttle controller 214 can determine new states 242 and 244 for the cooling system 204 and/or the system 106. For example, the throttle controller 214 can use the new state 242 to decrease the speed of the fan 222 and conserve power. Additionally or alternatively, the throttle controller 214 can use the new state 244 to improve the performance of the system 106 and to improve the user experience. An example relationship between the measured temperature data 226, the forecasted temperature data 236, the temperature limit 110, and the target temperature 240 is further described with respect to FIG. 3.

FIG. 3 illustrates example timing diagrams 300-1 and 300-2 depicting proactive thermal throttling based on forecasted temperature data 236. In the timing diagram 300-1, the measured temperature data 226 and the forecasted temperature data 236 is depicted over time. The measured temperature data 226 starts to increase and the forecasted temperature data 236 indicates that the measured temperature data 226 is likely to continue increasing at least up to the target temperature 240.

At time T1, the forecasted temperature data 236 is equal to the target temperature 240. This causes the thermal control system 112 to activate the fan 222. As shown in the timing diagram 300-2, the fan 222 is turned on at T1 and its speed is continually increased until the forecasted temperature data 236 decreases and approaches the target temperature 240. At time T2, the forecasted temperature data 236 and the measured temperature data 226 settle at the target temperature 240. As can be seen at 300-1, proactive thermal throttling 116 based on the forecasted temperature data 236 enables the measured temperature data 226 to remain below the temperature limit 110. The temperature forecasting 114 can be performed in a variety of different ways, as further described with respect to FIGS. 4 and 5.

FIG. 4 illustrates a first example machine-learned model 216 that performs temperature forecasting 114. In the depicted configuration, the machine-learned model 216 includes a feature extractor stage 402, a sequence summarizer stage 404, and a forecasting stage 406. The feature extractor stage 402 can be implemented using at least one convolutional neural network 408 (CNN 408). The convolutional neural network 408 receives input data 410 from the one or more data-generating components 202. The convolutional neural network 408 is trained to extract features 412 from the input data 410 and to recognize patterns in the input data 410. Using the convolutional neural network 408, the feature extractor stage 402 can help reduce a complexity and keep a size of the subsequent stages manageable.

The input data 410 at least includes the measured temperature data 226. In some implementations, the input data 410 also includes the measured secondary data 230 (e.g., the power samples 232) and/or the status data 234. The types of input data 410 and/or the quantity of different types of input data 410 can impact a complexity of the machine-learned model 216, the training of the machine-learned model 216, and/or an accuracy of the forecasted temperature data 236. In general, the input data 410 represents historical data that is obtained over a particular time period. The feature extractor stage 402 extracts context features 412 from the input data 410 and passes these features 412 to the sequence summarizer stage 404.

The sequence summarizer stage 404 can be implemented using an encoder recurrent neural network 414 (Encoder RNN 414). In example implementations, the encoder recurrent neural network 414 can be implemented using gated recurrent units (GRUs). The sequence summarizer stage 404 uses the encoder recurrent neural network 414 to encode the features 412 into a context vector 416. The sequence summarizer stage 404 passes the context vector 416 to the forecasting stage 406.

The forecasting stage 406 can be implemented using a decoder recurrent neural network 418 (decoder RNN 418). In example implementations, the decoder recurrent neural network 418 can be implemented using gated recurrent units (GRUs). Using the decoder recurrent neural network 418, the forecasting stage 406 generates the forecasted temperature data 236 based on the context vector 416. The forecasted temperature data 236 can be passed to the throttle controller 214, as shown in FIG. 2. While the machine-learned model 216 shown in FIG. 4 can generate accurate forecasted temperature data 236 for performing proactive thermal throttling 116 in a variety of different types of computing devices 102, other example implementations of the forecaster 212 can be implemented with an inference loop and a learning loop, as further described with respect to FIG. 5.

FIG. 5 illustrates an example implementation of the forecaster 212 for performing thermal forecasting 114. In the depicted configuration, the forecaster 212 includes an inference loop 502 and a learning loop 504. The inference loop 502 generates the forecasted temperature data 236 and corrects, at least partially, for an amount of error that is determined by the learning loop 504. The inference loop 502 and the learning loop 504 enable the forecaster 212 to have improved responsiveness and improved accuracy, which can be helpful in situations in which the target temperature 240 is relatively close to the temperature limit 110.

The inference loop 502 includes a combination of the pre-trained machine-learned model 216 and an adaptive machine-learned model 506. The parameters and behavior of the adaptive machine-learned model 506 are controlled by the learning loop 504. In an example implementation, the machine-learned model 216 is implemented using the architecture described in FIG. 4. The quantity of layers and the quantity of units in each layer of the adaptive machine-learned model 506 can be chosen to reduce computational expenditure and to mitigate the overhead associated with re-training of the adaptive machine-learned model 506. In an example implementation, the adaptive machine-learned model 506 can be implemented using a trainable linear model.

The inference loop 502 includes the machine-learned model 216, the adaptive machine-learned model 506, a limiter 508, a combiner circuit 510, and optionally includes an input selector 512. The learning loop 504 includes a measured data buffer 514, a forecast data buffer 516, an error calculator 518, and adaptive training logic 520. The measured data buffer 514 and the forecast data buffer 516 can be implemented using any type of memory storage mechanism.

During operations, the inference loop 502 receives the input data 410. The input selector 512 filters the input data 410 to provide at least a portion of the input data 410 to the adaptive machine-learned model 506 and to the measured data buffer 514. The portion of the input data 410 at least includes the measured temperature data 226. In general, the measured data buffer 514 stores at least the measured temperature data 226. The measured data buffer 514 can also store any additional data that is passed by the input selector 512 to the adaptive machine-learned model 506.

The machine-learned model 216 generates baseline forecasted temperature data 522 based on the input data 410. The baseline forecasted temperature data 522 represents a version of the forecasted temperature data 236 that does not include a correction based on the adaptive machine-learned model 506. The baseline forecasted temperature data 522 can also be referred to as uncorrected forecasted temperature data. The forecast data buffer 516 stores the baseline forecasted temperature data 522.

The error calculator 518 aligns, in time, the measured temperature data 226 from the measured data buffer 514 to the corresponding baseline forecasted temperature data 522 that is stored in the forecast data buffer 516. The error calculator 518 further compares the time-aligned measured temperature data 226 to the corresponding baseline forecasted temperature data 522. Based on this comparison, the error calculator 518 determines an error 524, which can represent a difference between the measured temperature data 226 and the baseline forecasted temperature data 522. The adaptive training logic 520 generates new weights 526 based on the data stored by the measured data buffer 514 and based on the error 524. In an example implementation, the adaptive training logic 520 computes the new weights 526 of the adaptive machine-learned model 506 using a gradual descent (GD) algorithm.

The adaptive machine-learned model 506 determines, based on the data provided by the input selector 512 and using the new weights 526, a correction 528 that can improve an accuracy of the forecasted temperature data 236. The limiter 508 limits how much correction can be applied at a given time to provide a safeguard measure since the adaptive machine-learned model 506 has not been verified with the current weights. The limiter 508, for instance, generates a limited correction 530, which is smaller in magnitude compared to the correction 528. In an example implementation, the limiter 508 can constrain the correction 528 to be within a certain range, such as between +/−2 degrees Celsius. The combiner circuit 510 applies the limited correction 530 to the baseline forecasted temperature data 522 to generate the forecasted temperature data 236. For example, the combiner circuit 510 can generate the forecasted temperature data 236 based on a summation of the baseline forecasted temperature data 522 and the limited correction 530. The forecasted temperature data 236 shown in FIG. 5 can also be referred to as corrected forecasted temperature data.

Although the techniques for performing proactive thermal throttling 116 based on forecasted temperature data 236 are described with respect to controlling an internal temperature of the computing device 102, these techniques can generally be applied to other use cases that aim to maintain operations at some form of steady state through a control loop. Consider, for example, a drone that is to be able to hover at a particular location and counteract external forces such as gravity and wind. In this case, the techniques for thermal forecasting 114 can be adapted for position forecasting, and the forecaster 212 can be implemented using the machine-learned model 216 of FIG. 4 or the inference and learning loops 502 and 504 of FIG. 5 to generate forecasted position data. The drone can include a throttle controller that performs proactive position adjustment based on the forecasted position data. For example, the throttle controller can adjust an amount of power that is applied to each motor of the drone to adjust the motor speed. With proactive position adjustment based on forecasted position data, the drone can hover at a precise position and avoid back-and-forth jitter associated with other drones that do not perform proactive position adjustment based on forecasted position data.

### Example Methods

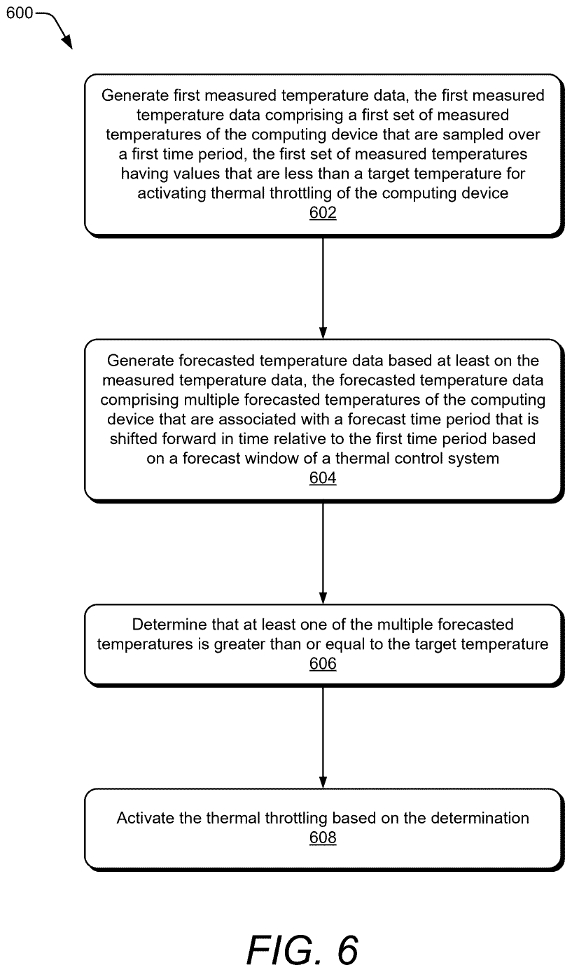

FIG. 6 depicts an example method 600 for implementing aspects of proactive thermal throttling based on forecasted temperature data. Method 600 is shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities detailed in FIG. 2, reference to which is made for example only. The techniques are not limited to performance by one entity or multiple entities operating on one device.

At 602, first measured temperature data is generated. The first measured temperature data comprises a first set of measured temperatures of the computing device that are sampled over a first time period. The first set of measured temperatures have values that are less than a target temperature for activating thermal throttling of the computing device.

For example, one or more thermal sensors 206 of the computing device 102 generate first measured temperature data 226, as shown in FIG. 2. The first measured temperature data 226 comprises a first set of measured temperatures of the computing device that are sampled over a first time period. The first set of measured temperatures represents a first set of temperature samples 228. The first set of measured temperatures have values that are less than the target temperature 240. For example, prior to time T1 in FIG. 3, the measured temperature data 226 has values that are less than the target temperature 240. The target temperature 240 represents a threshold for activating thermal throttling of the computing device 102 (e.g., for activating one or more cooling techniques). The target temperature 240 is set below the temperature limit 110. In some implementations, a difference between the temperature limit 110 and the target temperature 240 is less than or approximately equal to 1% of the temperature limit 110.

At 604, forecasted temperature data is generated based at least on the measured temperature data. The forecasted temperature data comprises multiple forecasted temperatures of the computing device that are associated with a forecast time period that is shifted forward in time relative to the first time period based on a forecast window of a thermal control system.

For example, the thermal control system 112 (and more specifically the forecaster 212) generates the forecasted temperature data 236 based at least on the measured temperature data 226. In some implementations, the thermal control system 112 can further generate the forecasted temperature data 236 based on the measured secondary data 230 (e.g., power samples 232) and/or status data 234. The forecasted temperature data 236 comprises multiple forecasted temperatures of the computing device 102 that are associated with a forecast time period that is shifted forward in time relative to the first time period based on the forecast window 238 of the thermal control system 112. In a first example implementation, the forecaster 212 can perform the temperature forecasting 114 using the machine-learned model 216 shown in FIG. 4. In a second example implementation, the forecaster 212 can perform the temperature forecasting 114 using the inference loop 502 and the learning loop 504 shown in FIG. 5.

At 606, at least one of the multiple forecasted temperatures is determined to be greater than or equal to the target temperature. For example, the thermal control system 112 (and more specifically the throttle controller 214) determines that at least one of the multiple forecasted temperatures is greater than or equal to the target temperature 240. In the example shown in the timing diagram 300-1, this determination occurs at time T1.

At 608, the thermal throttling is activated based on the determination. For example, the thermal control system 112 (and more specifically the throttle controller 214) activates thermal throttling based on the determination that at least one of the multiple forecasted temperatures is greater than or equal to the target temperature 240. To activate the thermal throttling, the thermal control system 112 can activate at least one active cooling technique and/or at least one passive cooling technique. For example, the thermal control system 112 can turn on the fan 222 and/or increase a speed of the fan 222, as shown between times T1 and T2 in the timing diagram 300-2 of FIG. 3. Additionally or alternatively, the throttle controller 214 can cause the system 106 to operate in a different state that consumes less power. For example, the throttle controller 214 can cause the system 106 to be powered off, operate with a slower clock frequency, operate with a lower supply voltage, operate with a radio access technology that utilizes less power, operate with a lower level of brightness or a lower volume level, and so forth.

### Conclusion

Although techniques using, and apparatuses including, proactive thermal throttling based on forecasted temperature data have been described in language specific to features and/or methods, it is to be understood that the subject of the appended claims is not necessarily limited to the specific features or methods described. Rather, the specific features and methods are disclosed as example implementations of proactive thermal throttling based on forecasted temperature data.

What is claimed is:

1. A computing device comprising:
at least one thermal sensor configured to generate first measured temperature data, the first measured temperature data comprising a first set of measured temperatures of the computing device that are sampled over a first time period, the first set of measured temperatures having values that are less than a target temperature for activating thermal throttling of the computing device; and
a thermal control system coupled to the at least one thermal sensor, the thermal control system configured to:
generate forecasted temperature data based at least on the first measured temperature data, the forecasted temperature data comprising multiple forecasted temperatures of the computing device that are associated with a forecast time period that is shifted forward in time relative to the first time period based on a forecast window of the thermal control system;
determine that at least one of the multiple forecasted temperatures is greater than or equal to the target temperature; and
activate the thermal throttling based on the determination.

2. The computing device of claim 1, wherein the thermal control system is further configured to perform at least one of the following actions to activate the thermal throttling:
activate a cooling system of the computing device; or
cause a system of the computing device to transition to a low-power state.

3. The computing device of claim 1, wherein:
the at least one thermal sensor is configured to generate second measured temperature data, the second measured temperature data comprising a second set of measured temperatures of the computing device that are sampled over a second time period, the second time period occurring after the first time period and after the activation of the thermal throttling; and
the thermal control system is further configured to control the thermal throttling to cause values of the second set of measured temperatures to be less than a temperature limit of the computing device, the temperature limit being greater than the target temperature.

4. The computing device of claim 3, wherein a difference between the temperature limit and the target temperature is less than or equal to one percent of the temperature limit.

5. The computing device of claim 1, further comprising:
at least one non-thermal sensor configured to generate measured secondary data, the measured secondary data comprising measured samples of an internal or external condition that provides context for the first measured temperature data, wherein:
the thermal control system is coupled to the at least one non-thermal sensor and is further configured to generate the forecasted temperature data based at least on the first measured temperature data and the measured secondary data.

6. The computing device of claim 5, wherein:
the at least one non-thermal sensor comprises a power measurement sensor configured to generate power samples that represent an amount of power that is consumed by the computing device; and
the thermal control system is configured to generate the forecasted temperature data based at least on the first measured temperature data and the power samples.

7. The computing device of claim 5, further comprising:
at least one status indicator configured to generate status data, the status data comprising samples of at least one operational configuration associated with the computing device, wherein:
the thermal control system is coupled to the at least one status indicator and is further configured to generate the forecasted temperature data based at least on the first measured temperature data, the measured secondary data, and the status data.

8. The computing device of claim 1, wherein the thermal control system comprises:
a machine-learned model configured to generate the forecasted temperature data based at least on the first measured temperature data.

9. The computing device of claim 8, wherein the thermal control system further comprises:
a learning loop configured to:
determine an error based on a comparison of the forecasted temperature data generated by the machine-learned model to time-aligned measured temperature data; and
generate new weights based at least on the error; and
an inference loop comprising:
the machine-learned model;
an adaptive machine-learned model configured to generate a correction based at least on the first measured temperature data and using the new weights; and
a combiner circuit configured to generate corrected forecasted temperature data based on a summation of the correction and the forecasted temperature data.

10. The computing device of claim 9, wherein:
the inference loop further comprises a limiter coupled between the adaptive machine-learned model and the combiner circuit, the limiter configured to generate a limited correction based on the correction; and
the combiner circuit is configured to generate the corrected forecasted temperature data based on a summation of the limited correction and the forecasted temperature data.
